(19) United States
(12) Patent Application Publication
(10) Pub. No.: US 2015/0226477 A1
(43) Pub. Date: Aug. 13, 2015

(54) HEAT EXCHANGER AND METHOD FOR THE INSTALLATION OF A GAS SEPARATION UNIT COMPRISING SUCH HEAT EXCHANGERS

(71) Applicant: L'AIR LIQUIDE,SOCIETE ANONYME POUR L'ETUDE ET L'EXPLOITATION DES PRO CEDES GEORGES CLAUDE, Paris (FR)

(72) Inventors: Frederic Crayssac, Velizy (FR); Benoit Davidian, Saint Maur Des Fosses (FR); Fabrice Del Corso, Saclay (FR); Sophie Deschodt, Emmerin (FR); Jean-Pierre Trainier, L'Hay-Les-Roses (FR); Marc Wagner, Saint Maur Des Fosses (FR)

(73) Assignee: L'Air Liquide Societe Anonyme pour l"Etude et lIExploitation des Procedes Georges Claude, Paris (FR)

(21) Appl. No.: 14/428,887

(22) PCT Filed: Aug. 29, 2013
(86) PCT No.: PCT/FR2013/051991

§ 371 Date: Mar. 17, 2015

(30) Foreign Application Priority Data
Sep. 19, 2012 (FR) 1258784

(51) Int. Cl. F25J 5/00; B23P 15/26

(52) U.S. Cl. CPC F25J 5/002; B23P 15/26

(57) ABSTRACT

The invention relates to a heat exchanger having parallel plates defining channels for heating or cooling fluids, spacers extending between the plates and defining channels, and an individual casing covering the plates and having a fireproof heat insulation layer.

### CROSS REFERENCE TO RELATED APPLICATIONS

This application is a § 371 of International PCT Application PCT/FR2013/051991, filed Aug. 29, 2013, which claims the benefit of FR1258784, filed Sep. 19, 2012, both of which are herein incorporated by reference in their entireties.

### TECHNICAL FIELD OF THE INVENTION

The present invention relates to a heat exchanger for forming a gas separation unit by heat transfer from at least one primary fluid, called calorigenic fluid, to at least one secondary fluid, called refrigerant. Moreover, the present invention relates to an installation method, for installing a cryogenics-based gas separation unit, the gas separation unit comprising at least two such heat exchangers.

The present invention is notably applicable in the field of gas separation by cryogenics. In particular, the present invention is applicable in the field of air separation by cryogenics.

### BACKGROUND

FR2844040A1 describes an exchanger assembly comprising two heat exchangers. Each heat exchanger comprises plates that are parallel to one another and that delimit fluid passages, and spacers defining channels. Furthermore, the exchanger assembly comprises input boxes and output boxes which connect each heat exchanger to primary manifolds and to secondary manifolds.

Furthermore, an exchanger assembly of the prior art requires a heat insulation structure which surrounds the exchanger assembly. The heat insulation structure generally comprises a metal framework supporting a double wall packed with a loose insulating material, such as perlite. This metal framework, this double wall and this insulating material are put in place on the site of operation of the exchanger assembly.

However, the heat insulation structure is complex, therefore costly. In particular, the production and assembly of the metal framework, of the double wall and of the insulating material take a long time and are costly. Furthermore, in such an exchanger assembly of the prior art, a leak of cryogenic fluid can reach supporting elements of the framework which is usually made of steel which is not resilient at low temperature, which can cause such supporting elements to break.

Furthermore, upon the separation of air by cryogenics in a heat exchanger made of aluminum alloy, the flow of oxygen at high pressure can cause a direct inflammation of the aluminum alloy at a hot point created locally by a plastic deformation, a brazing rupture, an impact of particles, flow frictions, etc. Now, the risk of direct inflammation increases with the service pressure in the heat exchanger.

### SUMMARY OF THE INVENTION

The present invention aims notably to solve, wholly or partly, the problems mentioned above.

To this end, the subject of the invention is a heat exchanger, for forming a gas separation unit by heat transfer from at least one primary fluid, called calorigenic fluid, to at least one secondary fluid, called refrigerant, the heat exchanger comprising at least:

a plurality of plates, the plates being arranged parallel to one another, the plates delimiting passages configured for the flow of calorigenic fluid or of refrigerant; and

heat exchange spacers which extend between the plates so as to define channels, each channel being adapted to channel a part of the calorigenic fluid or a part of the refrigerant;

the heat exchanger being characterized in that it further comprises a casing totally or partially covering the plurality of plates, the casing comprising at least one so-called fireproof heat insulation layer which is substantially fireproof in the temperature and pressure conditions of oxygen when the heat exchanger is in service, notably at a temperature of between +65° C. and −196° C. and at a pressure of between 1 bar A and 120 bar A.

Usually, “oxygen-compatible material” refers to a material that is substantially fireproof in the temperature and pressure conditions of oxygen when the heat exchanger is in service.

Thus, such a heat exchanger has an individual heat insulation, which makes it possible to speed up the installation of a gas separation unit on its site of operation. In effect, when the heat exchanger is delivered to the site of operation, its heat insulation has already been put in place on the site of production of the heat exchanger.

Furthermore, the so-called fireproof heat insulation layer limits, even avoids, the risks of inflammation in the presence of oxygen, which increases the safety of the operators and of the equipment. Generally, the flammability is great with a temperature between +65° C. and −196° C. and a pressure between 1 bar A and 120 bar A.

According to one embodiment of the invention, the fireproof heat insulation layer is formed from refractory ceramic fibers.

Thus, such refractory ceramic fibers form, for the heat exchanger, an effective heat insulation.

According to a variant of the invention, the refractory ceramic can be selected from the group consisting of a slag wool, a mineral wool such as rock wool or glass wool, artificial mineral fibers, alumina fibers, siliceous fibers, for example made of mulite.

According to one embodiment of the invention, said at least one fireproof heat insulation layer has a thickness of between 20 mm and 100 mm, preferably between 45 mm and 55 mm.

Thus, such a heat insulation layer formed from refractory ceramic contributes to effectively insulating the heat exchanger.

According to one embodiment of the invention, the casing is fixed to the plurality of plates by mechanical members such as lugs or dog points configured for snap-fitting or shrink-fitting.

Thus, such mechanical members make it possible to fix the casing reliably and rapidly.

According to one embodiment of the invention, the casing further comprises at least one heat insulation layer made of polyurethane or an equivalent organic heat insulation material, said at least one layer of polyurethane preferably having a thickness of between 150 mm and 350 mm.

Thus, such a polyurethane or equivalent heat insulation layer contributes to effectively insulating the heat exchanger.

According to one embodiment of the invention, the fireproof heat insulation layer covers a so-called cold part of the plurality of plates, and at least one polyurethane heat insulation layer covers a so-called hot part, the hot part being situated opposite the cold part, the temperature of the cold part being lower than the temperature of the hot part when the heat exchanger is in service.

Thus, the entire heat exchanger is effectively insulated, which does away with having to surround an enclosure with an additional heat insulation such as perlite in the prior art. Usually, the cold and hot parts are respectively called “cold end” and “hot end”.

In this embodiment, the fireproof heat insulation layer covers the cold part, which comprises oxygen in conditions of flammability. Whereas the hot part is covered by a possibly flammable heat insulation layer, such as polyurethane, because it does not exhibit conditions of flammability in the presence of oxygen. Thus, the cost of the heat insulation layers is optimized, by limiting the quantity of fireproof layer strictly needed.

According to a variant of the invention, the casing can further comprise a flammable heat insulation layer, such as polyurethane, which extends over the fireproof heat insulation layer. In effect, the outer surface of the fireproof heat insulation layer does not exhibit conditions of flammability, because it is at a temperature higher than the dewpoint of the air.

According to one embodiment of the invention, the heat exchanger is overall in the form of a rectangular parallelepiped, and the fireproof heat insulation layer comprises heat insulation panels each comprising at least two metal walls and at least one film of insulating material and arranged between two metal walls, the film of insulating material preferably being in a vacuum.

Thus, such a parallelepipedal form makes it possible to define passages for an effective heat transfer, particularly in a cryogenics-based gas separation unit.

Since the metal walls are fireproof and leaktight, the film of insulating material can be a flammable material, because it is not in contact with the oxygen.

According to one embodiment of the invention, the heat exchanger further comprises supply boxes configured to introduce or discharge calorigenic fluid or refrigerant fluid into or out of certain of said passages, the supply boxes being linked to the plurality of plates by mechanical fixing means, the mechanical fixing means preferably being selected from the group consisting of screws, rivets, snap-fitting elements and shrink-fitting elements.

Thus, such supply boxes can be linked to the plurality of plates very rapidly on the site of operation of the heat exchanger.

According to one embodiment of the invention, the heat exchanger further comprises suspension members, such as rods, hooks or lag screws, the suspension members consisting of thermally insulating material such as glass fibers, the suspension members being configured to make it possible to suspend the heat exchanger from beams, the suspension members being secured to the plurality of plates, preferably by welding or brazing.

Thus, such suspension members make it possible to handle the heat exchanger safely and rapidly on its site of operation.

According to a variant of the preceding embodiment, the suspension members are arranged toward the edges of the plurality of plates. Thus, the suspension members make it possible to balance the weight of the suspended heat exchanger.

Another subject of the present invention is an installation method, for installing a cryogenics-based gas separation unit, the gas separation unit comprising at least two heat exchangers according to the invention, the installation method comprising the steps of:

transporting at least two heat exchangers to the site of operation of the separation unit;

installing a frame comprising at least two beams which are substantially parallel and horizontal and which are supported by substantially vertical uprights, the beams and the uprights preferably being metal, for example made of carbon steel;

suspending each heat exchanger from two beams by means of suspension members consisting of thermally insulating material such as glass fibers; and

linking supply boxes to the plurality of plates by mechanical fixing means, the mechanical fixing means preferably being selected from the group consisting of screws, rivets, snap-fitting elements and shrink-fitting elements.

Thus, such an installation method makes it possible to rapidly install a cryogenics-based gas separation unit on its site of operation.

Furthermore, the installation method allows for an installation time saving, because it does not require any step for surrounding the heat exchangers with an enclosure with an additional thermal insulation such as perlite in the prior art, because of the effective insulation of each heat exchanger according to the invention.

According to one embodiment of the invention, the installation method further comprises the steps of:

securing couplings respectively to the supply boxes, preferably by welding; and

securing manifolds to respective couplings, preferably by welding.

Thus, such steps make it possible to completely set up the gas separation unit according to the invention.

According to a variant of the invention, the installation method further comprises steps for linking to the exchanger assembly conditioned air components, smoke discharge ducts and/or a central column. Thus, such steps make it possible to completely set up the gas separation unit according to the invention.

The embodiments of the invention and the variants of the invention mentioned above can be taken in isolation or in any technically possible combination.

### BRIEF DESCRIPTION OF THE DRAWINGS

The present invention will be well understood and its advantages will also become apparent in light of the following description, given purely as a nonlimiting example and with reference to the attached drawings, in which:

FIG. 1 is an exploded perspective schematic view of a heat exchanger according to the invention;

FIG. 2 is a perspective schematic view of the heat exchanger of FIG. 1;

FIG. 3 is a perspective schematic view of a part of an exchanger assembly according to the invention and comprising the heat exchanger of FIG. 1, during an assembly step; and

FIG. 4 is a view similar to FIG. 2 of the exchanger assembly of FIG. 2, during a subsequent assembly step.

### DETAILED DESCRIPTION

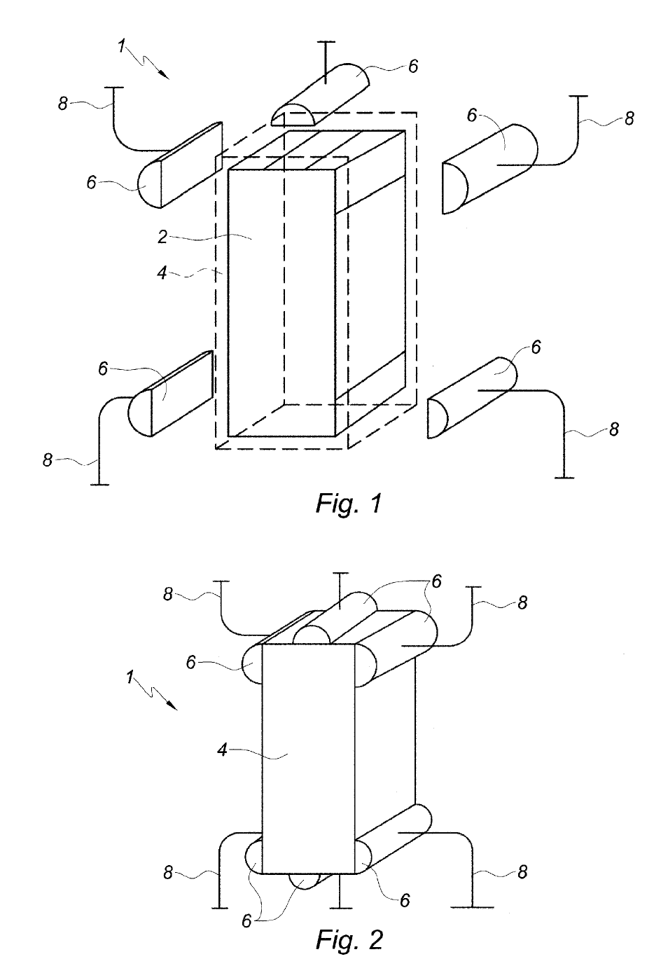

FIGS. 1 and 2 illustrate a heat exchanger 1, for forming a gas separation unit which is not represented, based on heat transfer from at least one primary fluid, called calorigenic fluid, to at least one secondary fluid, called refrigerant.

The heat exchanger 1 comprises a plurality of plates 2. As is known per se, the plates 2 are arranged parallel to one another. The plates 2 delimit passages which are not represented and which are configured for the flow of calorigenic fluid or of refrigerant.

In the example of FIGS. 1 and 2, each plate 2 is overall in the form of a rectangle. The heat exchanger 1 is overall in the form of a rectangular parallelepiped. The length of the heat exchanger 1 is, here, approximately 6 m, its width is approximately 2 m and its height is approximately 2 m.

By convention, the length of a heat exchanger is measured parallel to the direction of flow of the refrigerant in the passages. The width of a heat exchanger is measured at right angles to the length. The height of a heat exchanger is measured in the direction of stacking of its plates.

The heat exchanger 1 further comprises heat exchange spacers which are not represented. The heat exchange spacers extend between the plates 2 so as to define channels that are not represented. As is known per se, each channel is adapted to channel a part of the calorigenic fluid or a part of the refrigerant.

Furthermore, the heat exchanger 1 comprises a casing 4 which here totally covers the plurality of plates 2. The casing 4 comprises a thermal insulation layer formed from refractory ceramic fibers. The thermal insulation layer formed from refractory ceramic fibers here has a thickness of approximately 50 mm. The casing 4 therefore also has a thickness of approximately 50 mm.

The casing 4 is fixed to the plurality of plates 2 by mechanical members that are not represented, which are here formed by lugs configured for snap-fitting.

The casing 4 can further comprise thermal insulation panels pressed onto a thermal insulation layer. Each thermal insulation panel can comprise two metal walls and an insulating film in a vacuum between the metal walls.

The heat exchanger 1 further comprises supply boxes 6 which are configured to introduce or discharge calorigenic fluid or refrigerant into or out of the fluid passages. The supply boxes 6 are linked to the plurality of plates 2 by mechanical fixing means that are not represented. These mechanical fixing means can here be screws.

Furthermore, the heat exchanger 1 comprises tappings or couplings 8, the function of which is to connect the supply boxes 6 to primary or secondary manifolds, as is shown in FIG. 4 which is described hereinbelow.

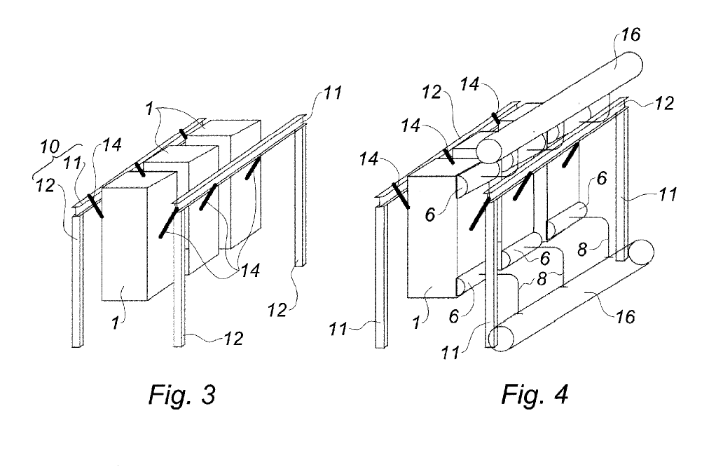

FIGS. 3 and 4 illustrate a step of a method of installing a cryogenics-based gas separation unit. This gas separation unit comprises three heat exchangers 1.

The installation method comprises the steps of:

transporting the heat exchangers 1 to the site of operation of the separation unit;

installing a frame 10 comprising two beams 11 which are substantially parallel and horizontal and which are supported by substantially vertical uprights 12; the beams 11 and the uprights 12 are here made of carbon steel;

suspending each heat exchanger 1 from the two beams 11 by means of suspension rods 14 consisting up of thermally insulating glass fibers; and

linking supply boxes 6 to the plurality of plates 2 by mechanical fixing means, in this case by screws.

Here, the assembly of the three heat exchangers 1 forms a battery of exchangers.

Furthermore, the installation method comprises the steps of:

securing couplings 8 respectively to the supply boxes 6, here by welding; and

securing manifolds 16 to respective couplings 8, here by welding.

After the installation method has been carried out, the cryogenics-based gas separation unit is installed in its site of operation.

The plates and the fins of the heat exchanger can be of aluminum or of refractory steel (for example Inconel®).

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-11. (canceled)

12. A heat exchanger, for forming a gas separation unit by heat transfer from at least one primary fluid, called a calorigenic fluid, to at least one secondary fluid, called a refrigerant, the heat exchanger comprising:
a plurality of plates, the plates being arranged parallel to one another, the plates delimiting passages configured for the flow of calorigenic fluid or of refrigerant; and
heat exchange spacers which extend between the plates so as to define channels, each channel being configured to channel a part of the calorigenic fluid or a part of the refrigerant;
a casing totally or partially covering the plurality of plates, the casing comprising at least one fireproof heat insulation layer which is substantially fireproof in the temperature and pressure conditions of oxygen when the heat exchanger is in service and at a temperature of between +65° C. and −196° C. and at a pressure of between 1 bar A and 120 bar A.

13. The heat exchanger as claimed in claim 12, in which the fireproof heat insulation layer is formed from refractory ceramic fibers.

14. The heat exchanger as claimed in claim 12, in which said at least one fireproof heat insulation layer has a thickness of between 20 mm and 100 mm.

15. The heat exchanger as claimed in claim 12, in which said at least one fireproof heat insulation layer has a thickness of between 45 mm and 55 mm.

16. The heat exchanger as claimed in claim 12, in which the casing is fixed to the plurality of plates by mechanical members configured for snap-fitting or shrink-fitting.

17. The heat exchanger as claimed in claim 12, where the mechanical members are selected from the group consisting of lugs, dog points, and combinations thereof.

18. The heat exchanger as claimed in claim 12, in which the casing further comprises at least one heat insulation layer made of polyurethane or an equivalent organic heat insulation material.

19. The heat exchanger as claimed in claim 18, wherein said at least one polyurethane heat insulation layer has a thickness of between 150 mm and 350 mm.

20. The heat exchanger as claimed in claim 18, in which the fireproof heat insulation layer covers a cold part of the plurality of plates, and in which at least one polyurethane heat insulation layer covers a hot part, the hot part being situated opposite the cold part, the temperature of the cold part being lower than the temperature of the hot part when the heat exchanger is in service.

21. The heat exchanger as claimed in claim 12, in which the heat exchanger is overall in the form of a rectangular parallelepiped, and in which the fireproof heat insulation layer comprises heat insulation panels each comprising at least two metal walls and at least one film of insulating material arranged between two metal walls.

22. The heat exchanger as claimed in claim 21, wherein the film of insulating material is in a vacuum.

23. The heat exchanger as claimed in claim 12, further comprising supply boxes configured to introduce or discharge the calorigenic fluid or the refrigerant into or out of certain of said passages, the supply boxes being linked to the plurality of plates by mechanical fixing means, the mechanical fixing means preferably being selected from the group consisting of screws, rivets, snap-fitting elements, shrink-fitting elements, and combinations thereof.

24. The heat exchanger as claimed in claim 12, further comprising suspension members, such as rods, hooks or lag screws, the suspension members having thermally insulating material, the suspension members being configured to suspend the heat exchanger from beams, the suspension members being secured to the plurality of plates.

25. The heat exchanger as claimed in claim 24, wherein the suspension members are selected from the group consisting of rods, hooks, lag screws, and combinations thereof.

26. The heat exchanger as claimed in claim 24, wherein the thermally insulating material is glass fibers.

27. The heat exchanger as claimed in claim 24, wherein the suspension members are secured to the plurality of plates by welding or brazing.

28. An installation method, for installing a cryogenic-based gas separation unit, the gas separation unit comprising at least two heat exchangers as claimed in claim 12, the installation method comprising the steps of:
transporting at least two heat exchangers to the site of operation of the separation unit;
installing a frame comprising at least two beams which are substantially parallel and horizontal and which are supported by substantially vertical uprights, the beams and the uprights preferably being metal, for example made of carbon steel;
suspending each heat exchanger from two beams by means of suspension members, wherein the suspension members are made of a thermally insulating material; and
linking supply boxes to the plurality of plates by mechanical fixing means, the mechanical fixing means preferably being selected from the group consisting of screws, rivets, snap-fitting elements, shrink-fitting elements, and combinations thereof.

29. The installation method as claimed in claim 28, further comprising the steps of:
securing couplings respectively to the supply boxes; and
securing manifolds to respective couplings.
